(19) United States
(12) Patent Application Publication
(10) Pub. No.: US 2004/0126201 A1
(43) Pub. Date: Jul. 1, 2004

(54) Color-coded staples

(76) Inventors: Brian Kobylinski, Mequon, WI (US); Michael Masino, Greendale, WI (US); Richard Glesner, Waukesha, WI (US); Jeffrey Baldwin, Waukesha, WI (US)

Correspondence Address: QUARLES & BRADY LLP, 411 E. WISCONSIN AVENUE, SUITE 2040, MILWAUKEE, WI, 53202-4497, US

(21) Appl. No.: 10/636,938

(22) Filed: Aug. 7, 2003

Related U.S. Application Data
(60) Provisional application No. 60/402,862, filed on Aug. 9, 2002.

(51) Int. Cl. F16B 31/02

(52) U.S. Cl. 411/13

(57) ABSTRACT

Color-coded staples and a method of associating staples with electrical cabling is disclosed in which the staples are colored according to the gauge wire in the cables to be secured by the staples. The cables include electrically conductive wire of a particular gauge size. A color scheme is identified for the exterior of the cables in which one cable is colored to represent its associated gauge wire and another cable having a different gauge wire is colored a different color to represent its associated gauge wire. Preferably, there are at least two different staple sizes, each size has staples colored to match the different colored cables that can be secured by that size staple.

### CROSS-REFERENCE TO RELATED APPLICATION

This application claims benefit of U.S. Provisional Patent Application No. 60/402,862 filed Aug. 9, 2002.

### STATEMENT OF FEDERALLY SPONSORED RESEARCH OR DEVELOPMENT

Not applicable.

### BACKGROUND OF THE INVENTION

The present invention relates to wire staples and in particular to color coded staples.

Conventional electrical wire for buildings comes as a bundle of two or three insulated conductor wires and a ground. These wires are contained in a rubber or plastic sheath so that rigid conduit is not required to meet the code regulations in many parts of the United States. One type of such wire is know as non-metallic building wire, or NM-B cable. One common source for such wire is the Southwire Company, of Carrollton, Ga., under the name Romex®. The wire is produced with various gauge conductors, ranging for example from #14 to #6. Since this type of wire is not run through rigid conduit, it is ordinarily required to be secured to wall studs or other supporting surfaces by wire fasteners, commonly called “staples”.

Wire staples can be actual staples, but are ordinarily hammered in place. They can be one-piece inverted U-shaped nails, or more commonly, they have a separate plastic inverted U-shaped body that fits over the cable and two nails disposed through openings on each side of the cable.

Building codes in many areas require that building wire be secured at prescribed intervals using appropriately sized staples. The right size staple depends on the number and gauge of wires in the cable. More wires and/or lower gauge wires widens the cable (and vice versa). If the staples are too narrow for the cable, the sheathing or the wire conductor or insulation could be cut when the staples are installed, and if they are too large, they may not sufficiently clamp the cable in place.

To make it easier for contractors and site inspectors to identify the gauge of wire in the cabling, some wire manufacturers are coloring the cables according to a standard color scheme based on the gauge of the wire. The outer sheath of the cable is colored a unique color that represents the gauge of wire therein. This gives the installer visual feedback on which gauge wire is being run and allows the inspector to quickly verify that the appropriate wire has been used.

Conventional staples are generally the same color regardless of size. The only indication of what size staple to use for a given size wire is typically on the product packaging or possibly a dimension marking on top of the staple. Generally, contractors and inspectors must still manually select and verify the appropriate size staple for a particular gauge wire. Also, as color-coded cable gains popularity, using conventional staples that are similar in appearance and do not coordinate with the cable may reflect poorly on the contractor by giving an unprofessional impression to the general contractor, the inspector or the owner of the building.

### SUMMARY OF THE INVENTION

The present invention provides staples coded according to the gauge of wire in the cabling that they are used to secure.

In one aspect the invention provides staples for securing cabling having electrically conductive wire within sheathing of a color selected according to the gauge of wire in the cabling. At least two cables having different gauge wire are colored differently. The staples have bodies and a pair of spikes defining a downwardly opening pocket sized to receive a cable. At least two staples have bodies of different colors substantially matching the colors of the respective at least two cables.

Another aspect of the invention provides a method of associating staples with cables. The method includes identifying a color scheme for the exterior of the cable in which a first cable having a first gauge wire is a first color and a second cable having a second gauge wire is a second color different from the first color. Some or all of the staples are then colored such that a first staple is substantially the first color and a second staple is substantially the second color.

The color scheme can include for third and fourth cables having respective third and fourth gauge wire and the third and fourth staples can be colored different colors.

In one preferred form, the first gauge wire is 14 gauge and the associated cables and staples are white, the second gauge wire is 12 gauge and the associated cables and staples are yellow, the third gauge wire is 10 gauge and the associated cables and staples are orange, and the fourth gauge wire is 8 gauge and the associated cables and staples are black.

In other preferred forms, the staples include bodies defining downwardly opening pockets with openings on each side for spikes or nails used to mount the staples. An upper surface of the staple bodies preferably includes indicia indicating the width of the pockets.

In another form, the staples are generally U-shaped members having two substantially parallel spike legs each with a pointed end and a cross-leg extending between ends of the spike legs opposite the pointed ends. The cross-leg and adjacent upper portions of the spike legs are dip coated with a colored rubber or plastic, thus forming the colored staple body.

Thus, the present invention provides color coded staples following an industry standard color scheme for building wire, such as Romex®. Color coding the staples makes it easy to associate the proper staples to be used for a particular building cable or gauge of wire, which differ in size depending on the gauge and number of conductors therein. Rapid identification of the proper wire/staple combination saves time and frustration when purchasing supplies and during installation at the job site. Properly sizing the staples reduces the likelihood of puncturing wire, for example, if the staples are too small. It also helps ensure that the staples properly grip and secure the cable. Matching the staples to the colored wire also eases inspection of the work site, allowing the inspector to verify that the correctness of the cable and staples at glance. Coloring the staples also makes inventory management easier for suppliers and contractors since the products can be more readily identified and grouped.

These and still other advantages of the invention will be apparent from the detailed description and drawings. What follows is a preferred embodiment of the present invention. To assess the full scope of the invention the claims should be looked to as the preferred embodiment is not intended as the only embodiment within the scope of the invention.

### BRIEF DESCRIPTION OF THE DRAWINGS

FIG. 1 is a top view of a colored staple of the present invention;

FIG. 2 is a front view thereof;

FIG. 3 is a top view of color-matched wire and staples;

FIG. 4 is a top view of color-matched wire and staples of a different size and color than in FIG. 3; and

FIG. 5 is a front view of another embodiment of the color staple of the present invention.

### DETAILED DESCRIPTION OF THE PREFERRED EMBODIMENT

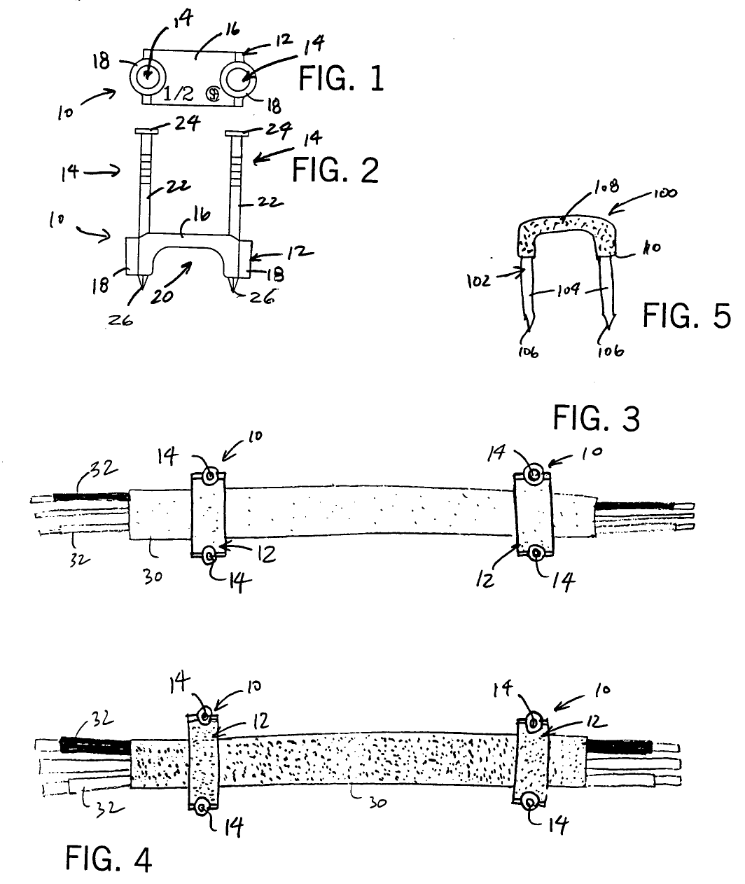

The present invention provides wire staples that are color matched to the gauge of wire in the cables. Referring to FIGS. 1 and 2, in one preferred embodiment, a staple 10 includes a staple body 12 and a pair of nails or spikes 14. The staple body 12 is preferably a rigid or semi-rigid plastic having a flat lateral top plate 16 and upright ends 18 defining a downwardly opening pocket 20. The pocket 20 can be any shape, however, many types of conventional non-metallic building cable are flat at two opposite sides so as to be relatively wider than tall. The pocket 20 defined by the staple body 12 is thus correspondingly shaped. The ends 18 of the staple body 12 are rounded and have openings (not shown) allowing the nails 14 to extend through the staple body 12. The nails have the conventional shaft 22, head 24 and pointed end 26 for being driven into a substrate, such as wall stud, to which the cable is being attached. The openings are dished or tapered inwardly at the top to accommodate the nail heads after being driven downwardly by a hammer when securing the staples in place. Each staple body 12 is preferably injection molded of a suitable colored plastic. The size of the pocket is preferably formed into the upper surface of the top plate 16.

The colors for the staple bodies 12 are selected to match (at least generally) the standard color scheme developed and followed by the producers of color-coded building cable. For example, such color coded cabling is commercially available from Southwire Company of Carrollton, Ga. and Encore Wire, Ltd., of McKinney, Tex., in NM-B, THHN and XHHW-2 types.

The wire has been color coded so that its outer sheath 30 (see FIGS. 3 and 4) signifies a particular gauge (or range of gauges) of conductor wires, such as conductors 32, within the sheath 30. Standard gauge wire for conventional residential and commercial building includes #6-#14. For NM-B type building wire, a standard color scheme, at least followed by the Southwire Company, is as follows:

| Gauge | Color |
|---|---|
| #14 | White |
| #12 | Yellow |
| #10 | Orange |
| #8 and #6 | Black |

The staple bodies are thus colored accordingly. Each staple could be sized and colored to match only one size and color of wire. However, since the overall width of the cabling does not vary dramatically for each gauge of wire, only two standard size staples is sufficient for common wire sizes. Preferably, the staples are either ½ or ¾ inches. As mentioned above, the size of the staple is indicated on the top of the staple body (as shown in FIG. 1), stated in fractional inches as the width or lateral dimension of the pocket (between the upright ends of the staple body). The ½ inch staples are suitable for use with 14-2, 12-2, 12-3 and 10-2 NB cable. The first number represents the gauge of the wire and the second represents the number of insulated conductors in the cable (in addition to the ground). The ¾ inch staples are designed for 14-3, 10-3, 8-2 and 6-2 cabling. The ½ inch staples would be colored either white, yellow or orange and the ¾ inch staples would be colored white, orange or black.

Thus, as shown in FIGS. 3 and 4, the color of the cable sheathing and the staple bodies match based on the gauge wire (represented in FIG. 3 by light stippling and in FIG. 4 by heavy stippling).

It should also be noted that the color coded staples could be used with conventional non-colored (white) cabling to identify the gauge of wire in the cable. The white cable would be secured with staples colored according to the gauge of wire in the cable. In this way, the staples would readily identify the gauge of wire in the cabling, even if the cabling did not.

FIG. 5 shows another embodiment of the present invention. Here, the staple 100 is comprised of a generally U-shaped nail member 102 having two substantially parallel spike legs 104 each with a pointed end 106 and a cross-leg 108 extending between ends of the spike legs 104 opposite the pointed ends 106. The staple body 110 is formed by dip coating the cross-leg 108 and adjacent upper portions of the spike legs 104 with a colored rubber or plastic, for example, polyvinylchloride or polyethylene, so that the staple body coating extends to approximately the cable contacting portions of staple when driven into the cabling supporting substrate. The same color scheme described above applies to this embodiment, however, the two standard sizes are ½″ wide (at the pocket between the legs) by 1″ long and 9/16″ by 1 ¼″.

Thus, the present invention provides color coded staples following an industry standard color scheme for building wire, such as Romex®. Color coding the staples makes it easy to associate the proper staples to be used for a particular building cable, which different in size depending on the gauge of the wire conductors therein.

It should be appreciated that a preferred embodiment of the invention has been described above. However, many modifications and variations to the preferred embodiment will be apparent to those skilled in the art, which will be within the spirit and scope of the invention. Therefore, the invention should not be limited to the described embodiment. To ascertain the full scope of the invention, the following claims should be referenced.

I claim:

1. A method of associating staples with cables having electrically conductive wire therein, the method comprising the steps of:
identifying a color scheme for the exterior of the cables in which a first cable having a first gauge wire is a first color and a second cable having a second gauge wire is a second color different from the first color; and
coloring the staples such that at least a portion of a first staple is substantially the first color and at least a portion of a second staple is substantially the second color.

2. The method of claim 1, wherein the identifying step further includes identifying a color scheme for third and fourth cables having respective third and fourth gauge wire and wherein the coloring step includes coloring third and fourth staples.

3. The method of claim 2, wherein the first gauge wire is 14 gauge, the second gauge wire is 12 gauge, the third gauge wire is 10 gauge, and the fourth gauge wire is 8 gauge.

4. The method of claim 3, wherein the first staple is white, the second staple is yellow, the third staple is orange and the fourth staple is black.

5. The method of claim 1, wherein each staple has a staple body defining a downwardly opening pocket and openings on each side of the pocket for spikes.

6. The method of claim 1, wherein the staple body includes size indicia on an upper surface.

7. The method of claim 1, wherein the staple is a generally U-shaped member having two substantially parallel spike legs each with a pointed end and a cross-leg extending between ends of the spike legs opposite the pointed ends.

8. The method of claim 7, further comprising a staple body coating at least the cross-leg.

9. The method of claim 8, wherein the coating is polyethylene.

10. The method of claim 8, wherein the polyethylene is applied using a dip coating technique.

11. Staples for securing cabling having electrically conductive wire within sheathing of a color selected according to the gauge of wire in the cabling such that at least two cables having different gauge wire are colored differently, the staples each having a staple body and a pair of spikes defining a downwardly opening pocket sized to receive a cable, wherein at least two staples have bodies of different colors substantially matching the colors of the respective at least two cables.

12. Staples for securing cabling having electrically conductive wire of a certain gauge, the staples each defining a downwardly opening pocket sized to receive a cable and having a staple body being of a color which is representative of the gauge of wire in the cable.
